(19) United States
(12) Patent Application Publication
(10) Pub. No.: US 2012/0067452 A1
(43) Pub. Date: Mar. 22, 2012

(54) THERMOPLASTIC HOSES FOR AIRBORNE VEHICLES

(76) Inventor: VALERIE BRIAND, Caudebec-Les-Elbeuf (FR)

(21) Appl. No.: 13/223,704

(22) Filed: Sep. 1, 2011

Related U.S. Application Data
(60) Provisional application No. 61/379,986, filed on Sep. 3, 2010.

(51) Int. Cl. B65B 31/00; F16L 11/00

(52) U.S. Cl. 141/1; 138/121; 138/137; 141/37

(57) ABSTRACT

Embodiments of the present invention provide thermoplastic hoses for an airborne vehicles. The hoses have an inner layer comprised of polyamide and an external layer of polyamide, and the hose is configured to allow the hose to both operate safely under pressures below 55 psi and withstand internal pressures of at least 15 pounds per square inch, and in specific embodiments, at least about 165 pounds per square inch. Specific embodiments of the hoses described are particularly useful on-board helicopters and smaller aircraft.

### CROSS REFERENCE TO RELATED APPLICATIONS

This application claims the benefit of U.S. Provisional Application Ser. No. 61/379,986, filed Sep. 3, 2010, titled “Thermoplastic Hoses for Airborne Vehicles,” the entire contents of which are hereby incorporated by reference.

### FIELD OF THE INVENTION

Embodiments of the present invention relate generally to hoses for use in airborne vehicles to transport fluids into the vehicle. In a particular embodiment, there are provided hoses specifically designed to transport fuel into helicopters. The hoses described are flexible, have a lower weight than current hoses, and can be manufactured less expensively.

### BACKGROUND

Airborne vehicles use numerous hoses in order to transport fluids such as fuel into the vehicle. Such hoses must withstand certain pressure and temperature gradients, as well as be fuel-tight in the event of a crash (i.e., crash-worthy). Hoses used for primary fuel systems on larger aircraft are typically straight (non-flexible) tubes, although some auxiliary fuel systems on large aircraft may use flexible hoses. Hoses used for helicopter applications are also generally flexible. Current hoses for use on airborne vehicles are typically designed of a stacked or layered configuration, which is typically a thin conductive inner layer of polytetrafluoroethylene (PTFE), a non-conductive external later of PTFE, and a reinforcing fabric, that can be made from various fibers such as glass fibers, and in some cases a reinforcing braid that can be made with aramid fibers.

PTFE is an engineered fluoropolymer that has an outstanding resistance to chemicals. It is known as being able to withstand broad temperature ranges from about of −67° F. to about 400° F. (−55° C. to 204° C.). It also has a low coefficient of friction, is chemically inert, does not deteriorate in service (its properties will not change due to weather and extreme temperatures), and withstands flexing and vibration without failure. These features make PTFE the primary choice of materials for aeronautical hoses. The PTFE hose is often reinforced with a glass fabric, and in some cases with a braid made of aramid, (such as Nomex or Kevlar), PVDF (such as Kynar), polyether ether ketone, PEEK, polypropylene, metallic fiber, or some other reinforcing material. PTFE generally has poor mechanical resistance (i.e., low stress at break resistance), so providing a fabric layer and optionally braided fibers around the hose helps ensure mechanical resistance. The braided fibers add increased pressure resistance to the hose and enhanced structural features. PEEK also has a relatively high density, which adds additional weight to the hose.

Hose design for the aeronautical industry is based on a combination of application and performance. Common factors to be considered are size, pressure rating, weight, length, and whether the hose should be straight or flexible. The flexible hoses that are currently used on-board aircraft are specifically designed to meet certain specifications for all types of aircraft. As a consequence, they are over-designed for use in smaller systems, rendering them too heavy and expensive. Because these standardized hoses are designed for a number of uses, they are stronger and heavier than needed for smaller systems, such as helicopters and smaller aircraft. In other words, the companies that manufacture aeronautical hoses address the widest variety of markets, and thus manufacture hoses that comply with regulations setting the highest pressure resistance requirements.

It is thus desirable to provide flexible hoses that can be used for fuel and other fluid transport into airborne vehicles that are lighter and less expensive to manufacture, but that can still withstand appropriate temperature and pressure ranges for the specified vehicle. For example, in one aspect, it is desirable to provide hoses for helicopters and other smaller aircraft that have decreased pressure requirements.

### BRIEF SUMMARY

Embodiments of the invention described herein thus provide hoses with geometries and designs that are compliant with aeronautic requirements in terms of pressures, temperatures, and aircraft fuel types.

### BRIEF DESCRIPTION OF THE DRAWINGS

FIG. 1 shows a schematic view of a cross-section of one embodiment of a hose for use on an airborne vehicle.

FIG. 2 shows a top perspective view of one embodiment of the hoses described herein.

FIG. 3 shows a cross-sectional view of the hose of FIG. 2.

FIG. 4 shows a cross-sectional view of one embodiment of a fitting for use with the hose of FIG. 2.

FIG. 5 shows a chart comparing weight of various hoses charted against operating pressures.

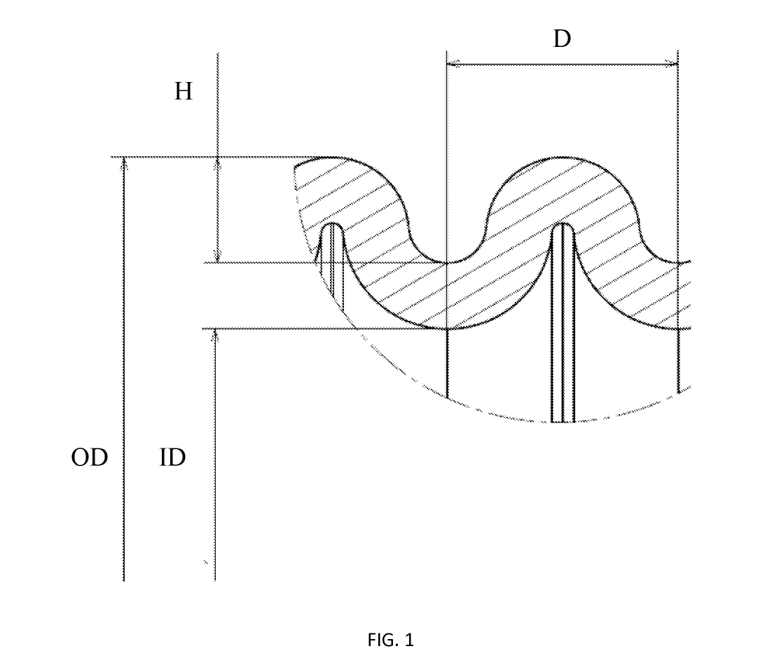

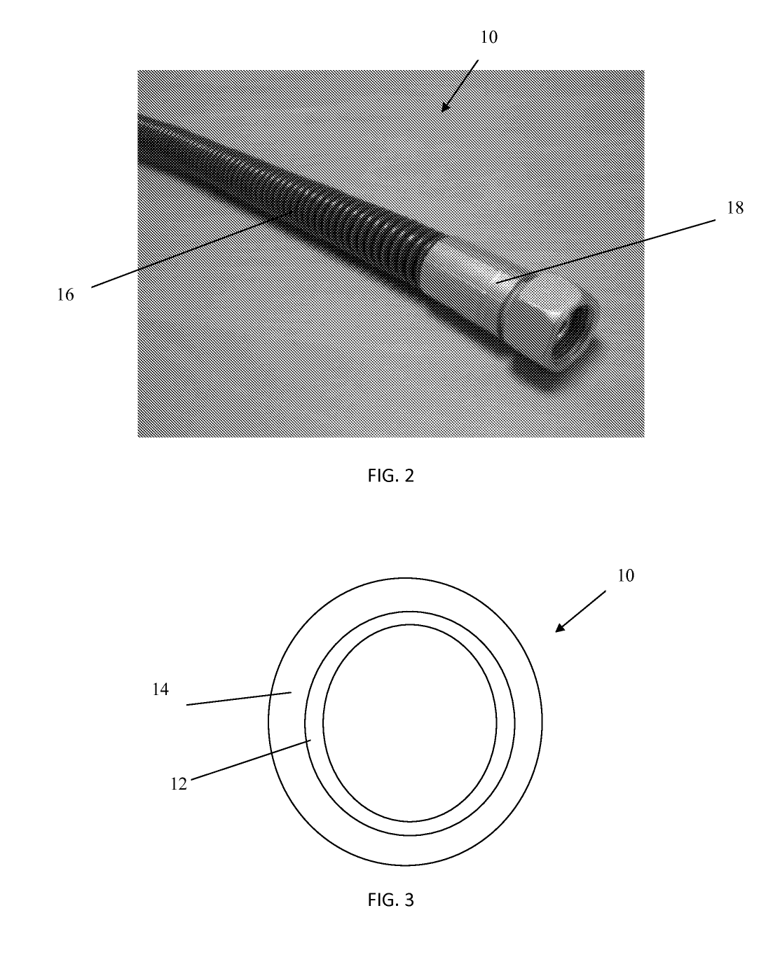

### DETAILED DESCRIPTION

Embodiments of the present invention provide hoses for use in airborne vehicles that have reduced weight and expense as compared to current aircraft hoses. Specific embodiments of the hoses 10 described are optimized for use on-board helicopters, and are thus designed with appropriate pressure and temperature resistances, diameters, and thicknesses that lend themselves to that particular industry. However, it should be understood that modifications to these parameters are possible in order to modify the hoses described for use in other types of aircraft. The hoses provided are corrugated or convoluted thermoplastic hoses 10 that are manufactured of a thin conductive inner layer 12 and an external layer 14. The inner layer 12 and external layer 14 may be manufactured from a thermoplastic material that has a stress at break of more than about 30 MPa (4350 PSI). It is particularly useful for the external layer 14 to have such a stress at break resistance. Additionally or alternatively, the material may have a density of less than about 1.4. In a specific embodiment, the material may be polyamide, and in an even more specific embodiment, the material may be polyamide 11 (PA 11). It should be understood that the inner and outer layers may be manufactured of the same or different materials. The use of materials having the above parameters renders the hose resistant to the applied pressures and aggressive environment experienced in an aeronautical field, but lighter than those currently being used. In one embodiment, the PA 11 material used is made from bio-sourced chemical substances and therefore can be referred to as environmentally friendly material in its definition and process. Other means can be envisioned to obtain the aforementioned PA11 material.

The choice of polyamide as a unique material for the hose results from multiple trade-offs which involve material cost, density, and mechanical stress at break. Table below shows the typical value of such parameters for some common thermoplastics:

| Thermo- | Typical 2011 | | Typical stress | Typical stress |
|---|---|---|---|---|
| plastic | prices in [symbol] /kg | Density | at break (Mpa) | at break (PSI) |
| FEP | 27 | 2.14 | 20 | 2900 |
| PFA | 40 | 2.14 | 28 | 4060 |
| PVDF | 19 | 1.78 | 50 | 7250 |
| ETFE | 35 | 1.72 | 45 | 6525 |
| PEEK | 100 | 1.3 | 100 | 14500 |
| PTFE | 20 | 2.18 | 24 | 3480 |
| PA 11 | 20 | 1.02 | 50 | 7250 |
| PPSU | 28 | 1.29 | 70 | 10150 |

Examples of reasonable choice criteria used in order to select the desired material for the hose, and in a specific embodiment, the criteria used to select polyamide 11 (PA11) as a potential hose material sought a material with low density, low cost and sufficient mechanical strength. In certain embodiments, PA 11 was selected because it has a density lower than about 1.4; has a cost lower than about 40 Euros per kilogram; and has a breaking strength higher than 30 MPa (megapascals) (4350 PSI). The polyamide 11 complies with all these criteria, but PPSU is another option. (Additional potential materials are possible, examples of which are included at the end of this application.) The above chart illustrates the advantage of PA11 over PTFE, notably in terms of density and mechanical strength.

It has been found that polyamide 11 provides a desirable combination of ranges of operating pressure and minimum burst pressure that is useful in helicopters and other small aircraft. For example polyamide 11 hoses can convey fluids at operating pressures below about 55 psi, but can also withstand not less than about 15 pounds per square inch of pressure (i.e., burst pressure) without failure. In a particular case, the hoses can withstand not less than about 165 pounds per square inch of pressure (i.e., burst pressure) without failure. These ranges provide hose 10 with the desired strength, but also the intended weight reduction and cost reduction.

Polyamide hoses have been used in the automotive industry, but automobile hoses have very different requirements and standards, and thus, different geometries, pressure resistance, thicknesses, and so forth than the aeronautical hoses described herein. For example, hose 10 is specifically designed with a thickness and pressure resistance that can withstand certain specified fuel pressures and temperatures, and that can safely transport fuel and other fluids (such as fuel vapors and air) into and through an aircraft. Aircraft fuel hoses 10 generally have an operating temperature range between about −54° C. to about 72° C. This allows them to be used in extreme temperatures without failure. By contrast, automotive hoses only need to have an operating temperature range between about −20° C. to about 60° C. They are not required to withstand such extreme environments.

Hoses 10 can also be safely operated at pressures of about 55 psi (pounds per square inch), which is the maximum pressure expected to be encountered in a helicopter fuel system. This pressure corresponds to the pressure at which helicopter fuel tanks are refueled under pressure (the pressure-refueling pressure). Maximum operating pressures in other parts of the system are usually lower than that and depend on the performance of the pumps that are used to transfer fuel. In some other cases, it happens that hoses in aircraft fuel system are operated under negative pressure (vacuum) of about (−) 5 psi at minimum. As a conservative design assumption, hoses must be design so that they allow safe operation of the fuel system between pressures of about (−) 5 psi to about 55 psi. Safe operation is ensured by designing the hose so it can resist the operating pressure with a certain margin of safety (most of the time, this factor is 3). Accordingly, hoses 10 are designed to withstand pressures of about −15 to about 165 psi. By contrast, the operating pressure in an automobile fuel system is about 120 mbars, which corresponds to about 1.74 psi. When conservatively applying the same safety design factors than in the aerospace industry, the pressure resistance of automotive fuel hoses is at least 5.22 psi. This is much lower that the pressure resistance required for hoses 10 that are designed for use in smaller aircraft. And by other contrast, the operating pressure in (and corresponding pressure resistance of) standard prior art hoses for use in the aircraft industry is much higher, adding increased weight and expense. By designing hoses 10 with an optimized pressure resistance range, the Applicant has been able to maximize the benefits of using materials that are novel to the aeronautical industry, as well as lessen the weight and expense of current hoses.

Diameters for hoses used in the helicopter industry are usually taken from SAE AS 1227 standard (Dash Number corresponds to multiples of 1/16″): 04, 06, 08, 10, 12, 16, 20, 24, 32, and higher. Other diameters within that same range can also be found, typically when diameters are expressed in metric units or conform to other European standards. Embodiments of hoses 10 that are designed for use in helicopter systems generally have diameters in the middle of that range. For example, hoses 10 may be provided in a number of diameters options, such as 8/16″, 10/16″ and 12/16″. The thickness of layers 12, 14 may be close to about 1 mm total, although the thicknesses of each layer may be increased or decreased to accommodate optimized for varying pressure resistances. For example, hoses 10 may have thicknesses ranging from about 0.3 mm to about 4 mm, although it is expected that an optimal thickness range is about 1 mm. The external layer 14 is generally thicker than the internal layer 12 in order to add increased strength and resistance to the hose 10. In some embodiments, the external layer 14 is about 5 to about 20 times the thickness of the internal layer 12.

In order to confirm that polyamide 11 (PA11) would be an acceptable material for use in manufacturing hoses for use in the aeronautical industry, fuel compatibility tests were conducted. Those working in the industry know that a material that has compatibility with one type of fuel does not mean that it will be compatible with a different type of fuel. Thus, extensive tests were performed to confirm that PA11 could be used to manufacture hoses for aeronautical use. For example, the potential types of fluids for testing include but are not limited to F34, F35, Fuel JP-4 JP-5, JP-8, RP-3, TS1, RT, F40, JETA, JETA1, JETB, F44, F43, PR3C, AVGAS, F12, F18, F22, F54, F75, F76, F46, F37, JP8+100, and additives include but are not limited to: Anti icing additive with a concentration of 0.30% by volume; EGME-NATO symbol S-748, MIL-1-27686, D.ENG.RD 2451 (AL-31), AIR3652B (_DCSEA 745); Fluid <<I>> (GOST 8313-88); Fluid <<I-M>> (TU6-10-1458-79); TGF (GOST 17477); and TGF-M (TU6-10-1457)

These tests were performed by ARZ showing compliance to the following requirements (see associated performance standard in brackets below for more information):

[MIL-DTL-8794§3.7.14] Fuel immersion in iso-octane toluene (70%-30% blend) during 72 hours at ambient temperature=>no visual degradation and proof pressure test passed

[SAE AS1227 §3.5.7 Flexibility and vacuum] Iso-octane fuel-filled hose is repeatedly bent at cold temperature and then at hot temperature under maintained negative pressure (vacuum)=>Inner diameter unchanged along hose, no visual degradation

Ageing in Jet A1 fuel=>15 days at 72° C. while pressurized: no visual degradation and burst pressure passed.

Whereas current aeronautical hoses obtain their pressure resistance from the fabric or braid that is positioned around the outside of the hose, Applicant has determined that, contrary to conventional wisdom, this fabric can be left out of the manufacturing process for aeronautical hoses 10. These fabrics and braids are expensive, and being able to manufacture a pressure resistant hose without their use can be a substantial savings. The hoses 10 can instead be PA 11 hoses that are corrugated or convoluted, which still provides the desired flexibility and a pressure resistance that is suitable for smaller aircraft. This prevents the use of large, heavy, expensive standardized hoses.

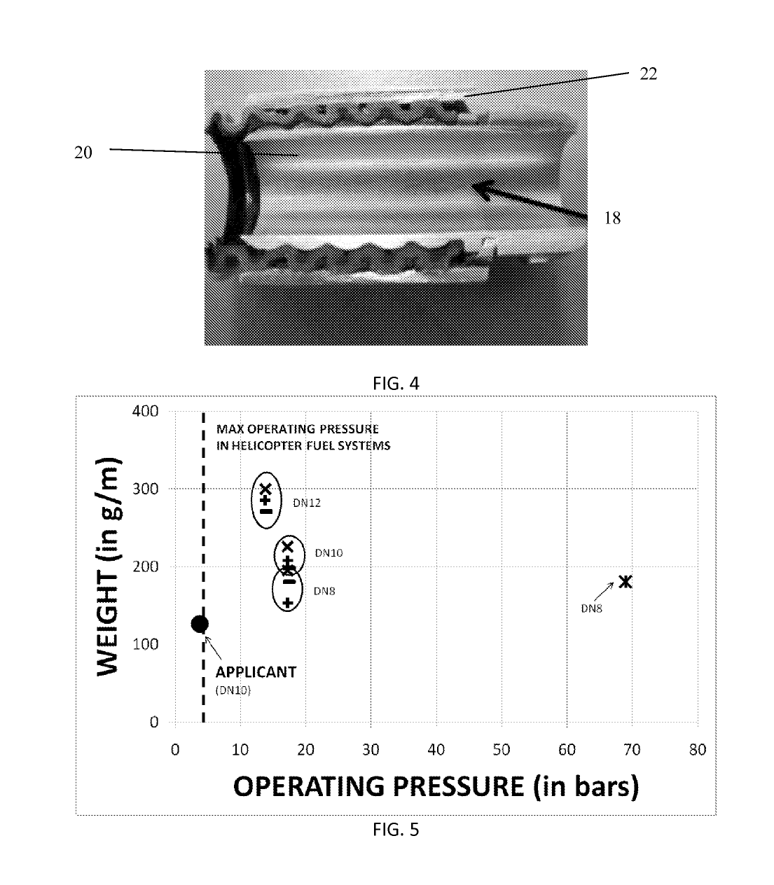

As illustrated in FIG. 4, each hose layer 12, 14 provides a portion of a double-walled hose 10. In one embodiment, manufacture of hose is a two-step process. The material comprising layers 12, 14 is first coextruded into a pipe, which provides a cylindrical pipe having two layers. Then, the pipe is pressed against a negative mold in order to provide the corrugations 16 on hose 10, and the material is cured or annealed. In other words, each of the layers 12, 14 is co-extruded and made by a corrugation process. By providing a corrugated hose, the hose can be easily bent at any number of angles without causing stress or other types of fatigue to the integrity of the hose.

The inner layer 12 has anti-static characteristics, which prevents the risk of static build-up during fuel loading. In one embodiment, these anti-static characteristic are such that the surface resistivity of the inner layer is less than 10⁹ ohm per square. It is important for hose 10 to be made of a static dissipative material, because fuel loading can create friction, causing static build-up of charges, which could in turn cause the fuel to ignite. Providing an anti-static inner layer 12 helps alleviate this potential problem.

As shown in FIGS. 3 and 5, an end fitting or connection 18 may be provided on the end of hose 10. Fittings 18 are typically metal components that are fitted to hose in order to allow hose to attach to fuel tank or fuel-related equipment. Fittings 18 may be crimped onto hose 10 in traditional fashion (using standard aeronautical “crimping,” but applied to corrugated hoses). For example, the hose may be crimped between two metallic parts by compression, a cross section of which is shown in FIG. 5. A fitting insert 20 is positioned inside the hose 10. This insert 20 has a “wavy” geometry that conforms with the inner “wavy” geometry of the hose, for a specified number of “waves” lengthwise.

A fitting body 22 is positioned on the outside of the hose at the same lengthwise location as the fitting insert 20. Fitting body 22 is then pressed against the fitting insert 20, such that they sandwich or otherwise crimp the hose 10 therebetween. It is also possible and envisioned that thermoplastic fittings may be provided that are thermoplastically molded onto or welded to the hose 10. Regardless of which type of fitting or method is used, the resulting fitted hose can accommodate all type of fitting nuts so as to be connected to another hose, a tank, a pump, a vent hole, a pass wall, or any other fuel system hardware equipment. Hoses may be used to transport fuel into and throughout the aircraft, as well as to vent aircraft tank(s) in order to monitor and adjust pressure in the tank(s). The hoses are thus designed to transport fuel, as well as fuel vapors, air, and any other appropriate fluids. The resulting assembly also has at least the same pressure resistance and the same lengthwise mechanical tensile strength as a stand-alone hose without fittings. In other words, fittings are designed to meet the same pressure resistance and mechanical fraction requirements as hose 10.

It should be understood that other materials are possible for use in connection with the features described herein. For example, the hose layers 12, 14 may be made from one or more of the following materials, and the inner and outer layers may be the same or different materials: other polyamide resins or copolymers (e.g., polyamide 4-6, polyamide 6, polyamide 12 aromatic PA such as PPA, and Polyarylamide), polyolefin resins, fluoro resins or copolymers, as well as polymers from the following families, PET, PEEK, PEKK, PEI, PET, PE, PPS, PPSU, PU, PI, PAI, . . . .

Changes and modifications, additions and deletions may be made to the structures and methods recited above and shown in the drawings without departing from the scope or spirit of the invention and the following claims.

What is claimed is:

1. A thermoplastic hose for an airborne vehicle, comprising:
an inner layer comprised of a thermoplastic material and an external layer comprised of a thermoplastic material, wherein the thermoplastic material of the external layer has a stress at break value of greater than about 30 MPa;
wherein the hose comprises a thickness and a diameter configured to allow the hose to convey fluid at operating pressures below about 55 pounds per square inch and withstand not less than about 15 pounds per square inch of pressure without failure.

2. The hose of claim 1, wherein the thermoplastic material comprises polyamide 11.

3. The hose of claim 1 wherein the fluid is fuel or a mix of air and fuel vapor.

4. The hose of claim 1, wherein in the inner layer and external later are corrugated or convoluted.

5. The hose of claim 1, wherein the inner layer and external layer are co-extruded.

6. The hose of claim 1, wherein the thickness of the hose is less than about 4 mm.

7. The hose of claim 1, wherein the diameter of the hose is greater than about 2/16 of an inch.

8. The hose of claim 1, wherein the inner layer has anti-static characteristics, such that its surface resistivity is lower than about 10⁹ ohm per square

9. The hose of claim 1, further comprising a fitting positioned on the hose.

10. The hose of claim 8, wherein the fitting is a metal fitting that is crimped onto the hose or a thermoplastic material fitting that is positioned on the hose via a standard thermoplastic process.

11. The hose of claim 10, wherein the standard thermoplastic process is welding or molding.

12. The hose of claim 1, wherein the hose is configured to withstand not less than about 165 pounds per square inch of pressure without failure.

13. An aircraft fuel system, comprising:
(a) a hose according to claim 1; and
(b) an aircraft fuel tank configured to deliver fuel from the aircraft fuel tank through the hose to an aircraft engine, to another aircraft fuel tank, to another aircraft fuel system component; or to vent air through the hose to or from an exterior of the aircraft or to and from another component of the fuel system.

14. The aircraft fuel system of claim 13, wherein the thermoplastic material is polyamide.

15. The aircraft fuel system of claim 13, wherein the hose is configured to withstand not less than about 165 pounds per square inch of pressure without failure.

16. The aircraft fuel system of claim 13, wherein the aircraft is a helicopter.

17. A method of conveying fluid within an aircraft fuel system, comprising:
(a) providing a hose according to claim 1;
(b) connecting the fitting to another hose, a tank, a pump, a vent hole, a pass wall, or fuel system hardware equipment;
(c) delivering fluid through the hose.

18. A thermoplastic hose for an airborne vehicle, comprising:
an inner layer comprised of a thermoplastic material and an external layer comprised of a thermoplastic material, wherein the thermoplastic material of the external layer has a density of less than about 1.4;
wherein the hose comprises a thickness and a diameter configured to allow the hose to convey fluid at operating pressures below about 55 pounds per square inch and withstand not less than about 15 pounds per square inch of pressure without failure.

19. The hose of claim 18, wherein the thermoplastic material comprises polyamide 11.

20. The hose of claim 18, wherein in the inner layer and external later are corrugated or convoluted and co-extruded.
